(19) United States
(12) Patent Application Publication
(10) Pub. No.: US 2025/0018989 A1
(43) Pub. Date: Jan. 16, 2025

(54) EXPANDABLE CART WITH UNFOLDABLE REAR FRAME

(71) Applicant: Jinhua Shanmu Leisure Products Co., Ltd., Jinhua (CN)

(72) Inventor: Xiangshan ZHANG, Jinhua (CN)

(73) Assignee: Jinhua Shanmu Leisure Products Co., Ltd., Jinhua (CN)

(21) Appl. No.: 18/239,172

(22) Filed: Aug. 29, 2023

(30) Foreign Application Priority Data
Jul. 12, 2023 (CN) 202321825520.7

(51) Int. Cl. B62B 3/02; B62B 3/00; B62B 5/06

(52) U.S. Cl. CPC B62B 3/02; B62B 3/002; B62B 5/065; B62B 2205/06; B62B 2205/20

(57) ABSTRACT

An expandable cart with an unfoldable rear frame includes a first column, a second column, a third column, a fourth column, a first folding mechanism, a second folding mechanism, a third folding mechanism, a bottom support mechanism, and a rear frame mechanism. The four columns are arranged at intervals in a rectangular shape, and have lower ends all connected to the bottom support mechanism, and the bottom support mechanism is capable of being folded upward. The first folding mechanism is connected between the first column and the second column, the second folding mechanism is connected between the third column and the fourth column, and the third folding mechanism is connected between the fourth column and the first column. The rear frame mechanism is disposed between the second column and the third column.

### CROSS REFERENCE TO THE RELATED APPLICATIONS

This application is based upon and claims priority to Chinese Patent Application No. 202321825520.7, filed on Jul. 12, 2023, the entire contents of which are incorporated herein by reference.

### TECHNICAL FIELD

The present disclosure relates to the technical field of foldable carts, and in particular, to an expandable cart with an unfoldable rear frame.

### BACKGROUND

In daily life and production, it is often necessary to carry luggage or articles, and carts are often used in this process. Carts are widely used because they can be pushed easily to save time and effort. To facilitate storage, carts are designed into a foldable light structure. After being folded, the cart can be placed in a car or backpack. It takes up little space and is easy to carry. However, the existing foldable carts still have the problem of a large size after being folded. Since the existing carts have a fixed volume after being fully unfolded, the ratio of the folded volume to the unfolded volume is large, making it impossible to haul relatively long articles, thus leading to insufficient flexibility. Moreover, the existing foldable carts with unfoldable rear frames are cumbersome to lay down and have poor practicability.

### SUMMARY

### (I) Technical Problems to be Solved

To overcome the above shortcomings of the prior art, the present disclosure provides an expandable cart with an unfoldable rear frame, which solves the technical problems of large volume after folding, insufficient flexibility and cumbersome laying-down operation.

### (II) Technical Solutions

To achieve the above objective, the expandable cart with an unfoldable rear frame of the present disclosure includes:
a first column, a second column, a third column, a fourth column, a first folding mechanism, a second folding mechanism, a third folding mechanism, a bottom support mechanism, and a rear frame mechanism, where
the first column, the second column, the third column, and the fourth column are arranged at intervals in a rectangular shape, and have lower ends all connected to the bottom support mechanism, and the bottom support mechanism is capable of being folded upward;
the first folding mechanism is connected between the first column and the second column, the second folding mechanism is connected between the third column and the fourth column, and the third folding mechanism is connected between the fourth column and the first column; and
the rear frame mechanism is disposed between the second column and the third column, a lower end of the rear frame mechanism is rotatably connected to a lower end of the second column and a lower end of the third column at a limited angle, and an upper end of the rear frame mechanism is detachably connected to an upper end of the second column and an upper end of the third column.

Optionally, the rear frame mechanism includes a fifth column, a sixth column, and a fourth folding mechanism, where
the fourth folding mechanism is connected between the fifth column and the sixth column, a lower end of the fifth column is rotatably connected to the lower end of the second column at a limited angle, a lower end of the sixth column is rotatably connected to the lower end of the third column at a limited angle, an upper end of the fifth column is capable of being engaged with the upper end of the second column, and an upper end of the sixth column is capable of being engaged with the upper end of the third column.

Optionally, a first top corner fastener is provided at each of the upper end of the fifth column and the upper end of the sixth column, and a hook is provided on the first top corner fastener;
a second top corner fastener is provided at each of the upper end of the second column and the upper end of the third column, and a groove is formed in the second top corner fastener; and
the hook on the fifth column and the hook on the sixth column are capable of being in one-to-one engagement with the groove in the second column and the groove in the third column.

Optionally, the fourth folding mechanism includes a first cross bent tube, a second cross bent tube, a first cross straight tube, a second cross straight tube, a first laying-down slide sleeve, and a second laying-down slide sleeve, where
the first laying-down slide sleeve and the second laying-down slide sleeve are in one-to-one slidable connection with the fifth column and the sixth column, respectively;
the first cross bent tube is rotatably connected to the second cross bent tube, a first end of the first cross bent tube is rotatably connected to the first top corner fastener on the fifth column, and a first end of the second cross bent tube is rotatably connected to the first laying-down slide sleeve;
the first cross straight tube is rotatably connected to the second cross straight tube, a first end of the first cross straight tube is rotatably connected to the first top corner fastener on the sixth column, and a first end of the second cross straight tube is rotatably connected to the second laying-down slide sleeve; and
a second end of the first cross bent tube is rotatably connected to a second end of the first cross straight tube, and a second end of the second cross bent tube is rotatably connected to a second end of the second cross straight tube.

Optionally, a support mechanism is provided between the second column and the third column, and the support mechanism includes a first transverse support tube, a second transverse support tube and a transverse support connector, where
a first end of the first transverse support tube is rotatably connected to the lower end of the second column, and a first end of the second transverse support tube is rotatably connected to the lower end of the third column; and
a second end of the first transverse support tube and a second end of the second transverse support tube are both rotatably connected to the transverse support connector.

Optionally, the expandable cart with an unfoldable rear frame further includes a first hanger rod and a second hanger rod, where
an upper end of the first hanger rod and an upper end of the second hanger rod are rotatably connected to a middle of the first folding mechanism and a middle of the second folding mechanism, respectively;
a first hanger rod joint is slidably arranged on the first hanger rod, a second hanger rod joint is slidably arranged on the second hanger rod, and limiting joints are respectively provided at a lower end of the first hanger rod and a lower end of the second hanger rod; and
the first hanger rod joint and the second hanger rod joint are both connected to the bottom support mechanism.

Optionally, the bottom support mechanism includes a first bottom connector, a second bottom connector, a plurality of first bottom connecting tubes, and a plurality of second bottom connecting tubes, where
the lower end of the first column, the first hanger rod joint, the second hanger rod joint and the lower end of the fourth column each are rotatably provided with one of the first bottom connecting tubes, and the first bottom connecting tubes are all rotatably connected to the first bottom connector; and
the first hanger rod joint, the lower end of the second column, the lower end of the third column and the second hanger rod joint each are rotatably provided with one of the second bottom connecting tubes, and the second bottom connecting tubes are all rotatably connected to the second bottom connector.

Optionally, the first folding mechanism and the second folding mechanism each include a first linkage, a second linkage, a third linkage, a fourth linkage, a fifth linkage, and a sixth linkage, where
the first linkage, the second linkage and the third linkage are rotatably connected end to end in sequence; the fourth linkage, the fifth linkage and the sixth linkage are rotatably connected end to end in sequence; a middle of the first linkage is rotatably connected to a middle of the fourth linkage, a middle of the second linkage is rotatably connected to a middle of the fifth linkage, and a middle of the third linkage is rotatably connected to a middle of the sixth linkage;
linkage slide sleeves are slidably arranged on the first column, the second column, the third column and the fourth column;
the first linkage of the first folding mechanism is rotatably connected to the upper end of the first column, the third linkage of the first folding mechanism is rotatably connected to the linkage slide sleeve on the second column, the first linkage of the second folding mechanism is rotatably connected to the upper end of the fourth column, and the third linkage of the second folding mechanism is rotatably connected to the linkage slide sleeve on the third column; and
the fourth linkage of the first folding mechanism is rotatably connected to the linkage slide sleeve on the first column, the sixth linkage of the first folding mechanism is rotatably connected to the upper end of the second column, the fourth linkage of the second folding mechanism is rotatably connected to the linkage slide sleeve on the fourth column, and the sixth linkage of the second folding mechanism is rotatably connected to the upper end of the third column.

Optionally, the third folding mechanism includes a seventh linkage, an eighth linkage, a ninth linkage, and a tenth linkage, where
a first end of the seventh linkage is rotatably connected to a first end of the eighth linkage, a first end of the ninth linkage is rotatably connected to a first end of the tenth linkage, a middle of the seventh linkage is rotatably connected to a middle of the ninth linkage, and a middle of the eighth linkage is rotatably connected to a middle of the tenth linkage; and
a second end of the seventh linkage is rotatably connected to the upper end of the first column, a second end of the eighth linkage is rotatably connected to the upper end of the fourth column, a second end of the ninth linkage is rotatably connected to the linkage slide sleeve on the first column, and a second end of the tenth linkage is rotatably connected to the linkage slide sleeve on the fourth column.

Optionally, the expandable cart with an unfoldable rear frame further includes a handle mechanism, where the handle mechanism includes a telescopic rod, a first connecting tube, and a second connecting tube, where a first end of the first connecting tube and a first end of the second connecting tube are both rotatably connected to a first end of the telescopic rod, and a second end of the first connecting tube and a second end of the second connecting tube are in one-to-one rotatable connection with the lower end of the first column and the lower end of the fourth column.

### (III) Beneficial Effects

When the cart is in a folded state, the four columns are gathered together, and the bottom support mechanism is folded upward among the four columns, thereby effectively reducing the volume of a cart frame, and facilitating storage and carrying. The first folding mechanism is connected between the first column and the second column, the second folding mechanism is connected between the third column and the fourth column, and the third folding mechanism is connected between the fourth column and the first column, thereby forming an enclosed space in cooperation with the bottom support mechanism for accommodating articles. The rear frame mechanism is disposed between the second column and the third column, a lower end of the rear frame mechanism is rotatably connected to a lower end of the second column and a lower end of the third column at a limited angle, and the rear frame mechanism can only rotate from a vertical state toward the outer side of the cart to a horizontal state, and forms an integral body with the bottom support mechanism, thereby expanding the length of the bottom support mechanism, and then expanding the storage space of the cart. An upper end of the rear frame mechanism is detachably connected to an upper end of the second column and an upper end of the third column, such that the rear frame mechanism can be quickly laid down or folded. The rear frame mechanism rotates to open one side surface of the cart, which expands the storage space of the cart, facilitates the placement and hauling of long articles, effectively improves the flexibility of cart space, and achieves the laying-down convenience of the rear frame mechanism.

### BRIEF DESCRIPTION OF THE DRAWINGS

FIG. 1 is a schematic structural diagram of an expandable cart with an unfoldable rear frame according to the present disclosure;

FIG. 2 is a schematic structural diagram of laying-down of a rear frame mechanism of an expandable cart with an unfoldable rear frame according to the present disclosure;

FIG. 3 is a top view of laying-down of a rear frame mechanism of an expandable cart with an unfoldable rear frame according to the present disclosure;

FIG. 4 is a side view of laying-down of a rear frame mechanism of an expandable cart with an unfoldable rear frame according to the present disclosure;

FIG. 5 is a schematic structural diagram of a third folding mechanism of an expandable cart with an unfoldable rear frame according to the present disclosure;

FIG. 6 is a schematic structural diagram of a folded state of an expandable cart with an unfoldable rear frame according to the present disclosure;

FIG. 7 is an enlarged view of A shown in FIG. 1; and

FIG. 8 is a partial schematic structural diagram of an expandable cart with an unfoldable rear frame according to the present disclosure.

### REFERENCE NUMERALS

11: First column; 12: Second column; 13: Third column; 14: Fourth column;
21: First folding mechanism; 211: First linkage; 212: Second linkage; 213: Third linkage; 214: Fourth linkage; 215: Fifth linkage; 216: Sixth linkage; 217: Linkage slide sleeve; 22: Second folding mechanism; 23: Third folding mechanism; 231: Seventh linkage; 232: Eighth linkage; 233: Ninth linkage; 234: Tenth linkage;
3: Rear frame mechanism; 31: Fifth column; 32: Sixth column; 33: Fourth folding mechanism; 331: First cross bent tube; 332: Second cross bent tube; 333: First cross straight tube; 334: Second cross straight tube; 335: First laying-down slide sleeve; 336: Second laying-down slide sleeve; 34: Hook; 35: First top corner fastener; 36: Second top corner fastener; 37: Groove;
4: Bottom support mechanism; 41: First bottom connector; 42: Second bottom connector; 43: First bottom connecting tube; 44: Second bottom connecting tube;
5: Support mechanism; 51: First transverse support tube; 52: Second transverse support tube; 53: transverse support connector;
61: First hanger rod; 62: Second hanger rod; 63: Second hanger rod joint; 64: Limiting joint; 65: First hanger rod joint;
7: Handle mechanism; 71: Telescopic rod; 72: First connecting tube; 73: Second connecting tube.

### DETAILED DESCRIPTION OF THE EMBODIMENTS

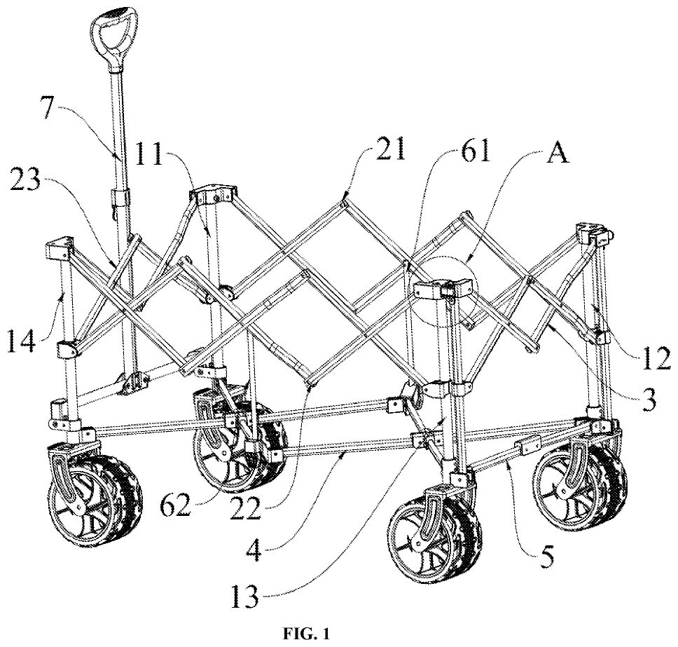

In order to better explain the present disclosure and facilitate understanding, the present disclosure is described in detail below with reference to the drawings and specific implementations. The terms such as “upper” and “lower” mentioned herein are based on the orientations shown in FIG. 1.

Although the drawings show the exemplary embodiments of the present disclosure, it should be understood that the present disclosure may be implemented in various forms and should not be limited to the embodiments set forth herein. On the contrary, these embodiments are provided such that the present disclosure is more fully understandable, and fully conveys the scope of the present disclosure to those skilled in the art.

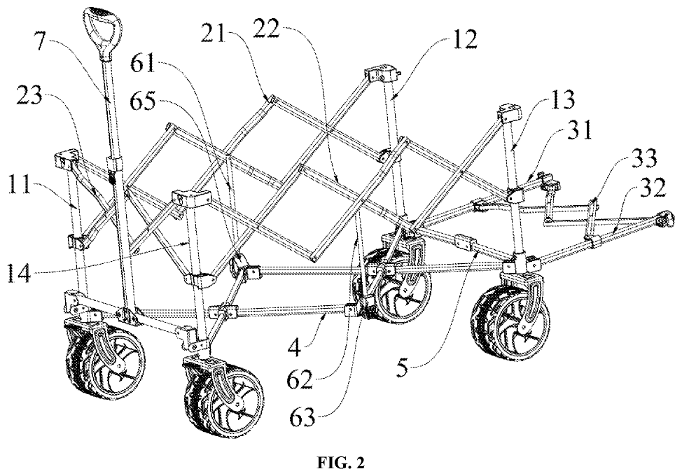

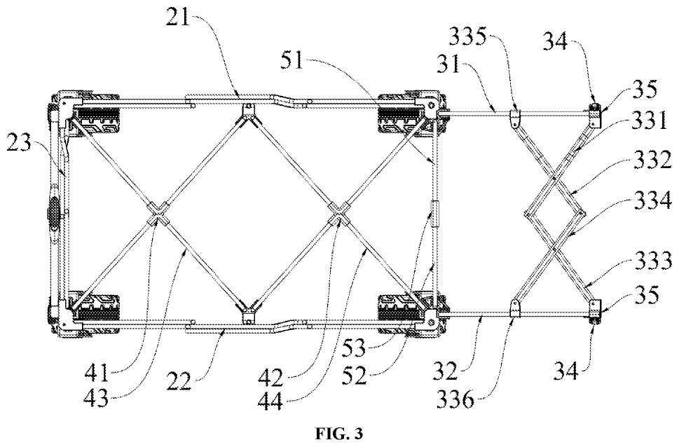

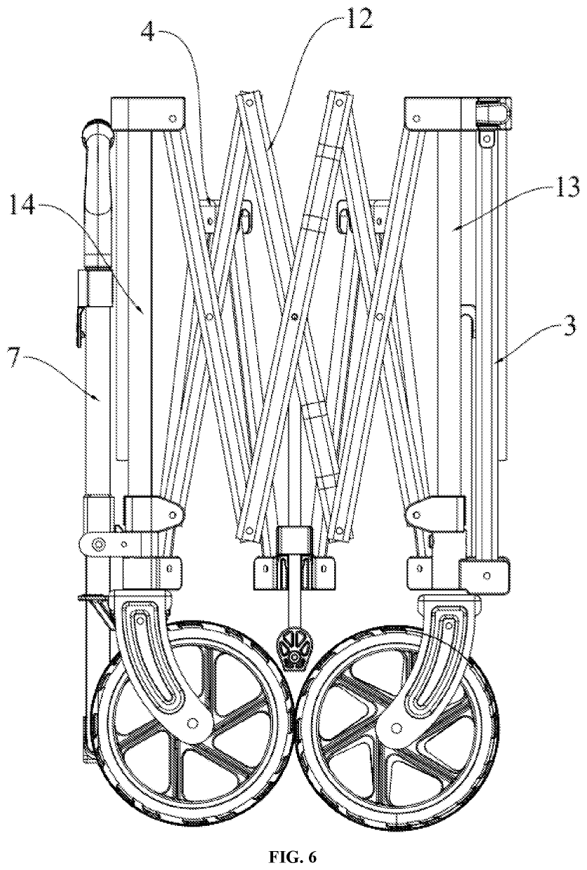

As shown in FIG. 1 to FIG. 8, the present disclosure provides an expandable cart with an unfoldable rear frame, including first column 11, second column 12, third column 13, fourth column 14, first folding mechanism 21, second folding mechanism 22, third folding mechanism 23, bottom support mechanism 4, and a rear frame mechanism 3. The first column 11, the second column 12, the third column 13 and the fourth column 14 are arranged at intervals in a rectangular shape when the cart is in an unfolded state, and a lower end of the first column 11, a lower end of the second column 12, a lower end of the third column 13 and a lower end of the fourth column 14 are all rotatably connected to the bottom support mechanism 4. When the cart is in a folded state, the four columns are gathered together, and the bottom support mechanism 4 is folded upward among the four columns, thereby effectively reducing the volume of a cart frame, and facilitating storage and carrying. The first folding mechanism 21 is connected between the first column 11 and the second column 12, the second folding mechanism 22 is connected between the third column 13 and the fourth column 14, and the third folding mechanism 23 is connected between the fourth column 14 and the first column 11, thereby forming an enclosed space in cooperation with the bottom support mechanism 4 for accommodating articles. The rear frame mechanism 3 is disposed between the second column 12 and the third column 13, a lower end of the rear frame mechanism 3 is rotatably connected to the lower end of the second column 12 and the lower end of the third column 13 at a limited angle, and the rear frame mechanism 3 can only rotate from a vertical state toward the outer side of the cart to a horizontal state, and forms an integral body with the bottom support mechanism 4, thereby expanding the length of the bottom support mechanism 4, and then expanding the storage space of the cart. An upper end of the rear frame mechanism 3 is detachably connected to an upper end of the second column 12 and an upper end of the third column 13, such that the rear frame mechanism 3 can be quickly laid down or folded. The rear frame mechanism 3 rotates to open one side surface of the cart, which expands the storage space of the cart, facilitates the placement and hauling of long articles, effectively improves the flexibility of cart space, and achieves the laying-down convenience of the rear frame mechanism.

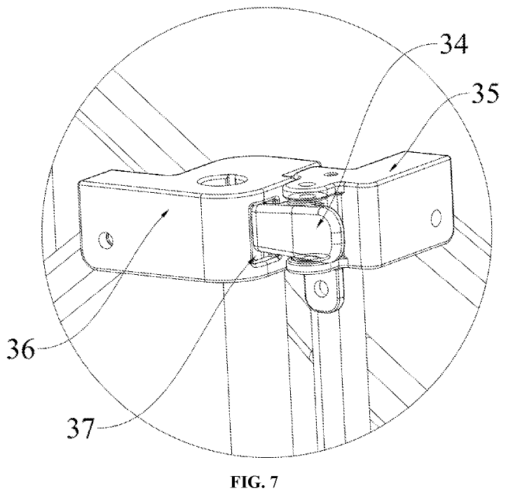

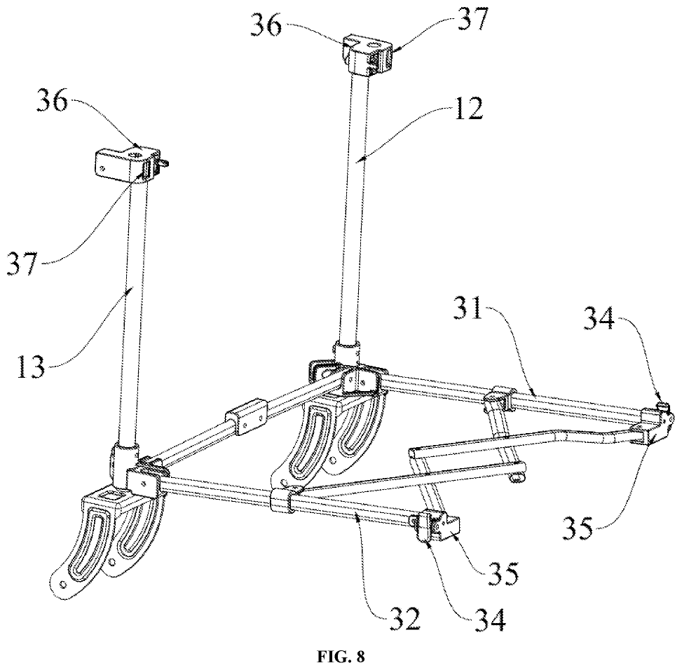

As shown in FIG. 1 to FIG. 4, the rear frame mechanism 3 includes fifth column 31, sixth column 32, and fourth folding mechanism 33. The fourth folding mechanism 33 is connected between the fifth column 31 and the sixth column 32. When the fourth folding mechanism 33 is folded, the fifth column 31 and the sixth column 32 approach each other. A lower end of the fifth column 31 is rotatably connected to the lower end of the second column 12 by means of a limiting groove at a limited angle, a lower end of the sixth column 32 is also rotatably connected to the lower end of the third column 13 by means of a limiting groove at a limited angle, and the fifth column 31 and the sixth column 32 can rotate only from the vertical state toward the outer side of the cart. An upper end of the fifth column 31 can be engaged with the upper end of the second column 12, and an upper end of the sixth column 32 can be engaged with the upper end of the third column 13, to achieve quick connection between the rear frame mechanism 3 and a cart body, thereby improving the folding and laying-down efficiency of the rear frame mechanism 3, and improving the operation convenience. Specifically, referring to FIG. 1, FIG. 7, and FIG. 8, first top corner fastener 35 is provided at each of the upper end of the fifth column 31 and the upper end of the sixth column 32, and hook 34 is provided on the first top corner fastener 35. The hook 34 is rotatably mounted on the first top corner fastener 35 through a mounting shaft, and a torsion spring is provided in middle. Second top corner fastener 36 is provided at each of the upper end of the second column 12 and the upper end of the third column 13, and groove 37 is formed in the second top corner fastener 36. The groove 37 is L-shaped, and includes a vertical groove configured to allow insertion of the hook 34 and a transverse groove configured to fix the hook 34. When the hook 34 is connected to the groove 37, the hook 34 is first inserted into the vertical groove, after the hook 34 enters the transverse groove through the vertical groove, the hook 34 is reset under the action of the torsion spring, and a protruding part on the hook 34 is snap-fitted in the transverse groove to fix the hook 34. The hook 34 on the fifth column 31 and the hook 34 on the sixth column 32 can be in one-to-one engagement with the groove 37 in the second column 12 and the groove 37 in the third column 13, thereby mounting and fixing the rear frame mechanism 3. When the cart is folded, the fourth folding mechanism 33 of the rear frame mechanism 3 can be folded and compressed, thereby ensuring that the fifth column 31 and the sixth column 32 can move together with the second column 12 and the third column 13.

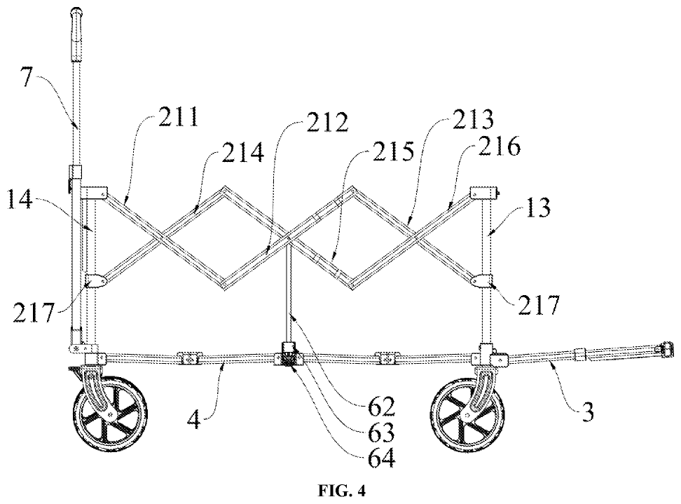

As shown in FIG. 4, the fourth folding mechanism 33 includes first cross bent tube 331, second cross bent tube 332, first cross straight tube 333, second cross straight tube 334, first laying-down slide sleeve 335, and second laying-down slide sleeve 336. The first laying-down slide sleeve 335 and the second laying-down slide sleeve 336 are in one-to-one slidable connection with the fifth column 31 and the sixth column 32, respectively. The first cross bent tube 331 is rotatably connected to the second cross bent tube 332, a first end of the first cross bent tube 331 is rotatably connected to the first top corner fastener 35 on the fifth column 31, and a first end of the second cross bent tube 332 is rotatably connected to the first laying-down slide sleeve 335. The first cross straight tube 333 is rotatably connected to the second cross straight tube 334, a first end of the first cross straight tube 333 is rotatably connected to the first top corner fastener 35 on the sixth column 32, and a first end of the second cross straight tube 334 is rotatably connected to the second laying-down slide sleeve 336. A second end of the first cross bent tube 331 is rotatably connected to a second end of the first cross straight tube 333, and a second end of the second cross bent tube 332 is rotatably connected to a second end of the second cross straight tube 334. When the cart is folded, the fourth folding mechanism 33 is folded at the same time, the fifth column 31 and the sixth column 32 approach each other, the first laying-down slide sleeve 335 and the second laying-down slide sleeve 336 slide downward, and the first cross bent tube 331, the second cross bent tube 332, the first cross straight tube 333 and the second cross straight tube 334 cross each other and rotate to a limit position.

As shown in FIG. 1 to FIG. 3, support mechanism 5 is provided between the second column 12 and the third column 13, and the support mechanism 5 includes first transverse support tube 51, second transverse support tube 52 and transverse support connector 53. A first end of the first transverse support tube 51 is rotatably connected to the lower end of the second column 12, a first end of the second transverse support tube 52 is rotatably connected to the lower end of the third column 13, and a second end of the first transverse support tube 51 and a second end of the second transverse support tube 52 are both rotatably connected to the transverse support connector 53. The transverse support connector 53 limits the second end of the first transverse support tube 51 and the second end of the second transverse support tube 52. After the first transverse support tube 51 and the second transverse support tube 52 rotate to a horizontal state, the second ends both abut against the transverse support connector 53, such that the first transverse support tube 51 and the second transverse support tube 52 are located on a same straight line, and are supported between the second column 12 and the third column 13 to provide an effective transverse support force for the second column 12 and the third column 13 after the rear frame mechanism 3 is laid down.

As shown in FIG. 1 to FIG. 4, the expandable cart with an unfoldable rear frame further includes first hanger rod 61 and second hanger rod 62. An upper end of the first hanger rod 61 and an upper end of the second hanger rod 62 are rotatably connected to a middle of the first folding mechanism 21 and a middle of the second folding mechanism 22, respectively. Specifically, the upper end of the first hanger rod 61 is connected to a rotatable connecting point between the second linkage 212 and the fifth linkage 215 of the first folding mechanism 21, and the upper end of the second hanger rod 62 is connected to a rotatable connecting point between the second linkage 212 and the fifth linkage 215 of the second folding mechanism 22. First hanger rod joint 65 is slidably arranged on the first hanger rod 61, second hanger rod joint 63 is slidably arranged on the second hanger rod 62, and the first hanger rod joint 65 and the second hanger rod joint 63 are both connected to the bottom support mechanism 4. Limiting joints 64 are respectively provided at a lower end of the first hanger rod 61 and a lower end of the second hanger rod 62, and the limiting joints 64 limit the first hanger rod joint 65 and the second hanger rod joint 63 to prevent the first hanger rod joint 65 and the second hanger rod joint 63 from being separated from the corresponding hanger rods.

As shown in FIG. 1 to FIG. 3, the bottom support mechanism 4 includes first bottom connector 41, second bottom connector 42, a plurality of first bottom connecting tubes 43, and a plurality of second bottom connecting tubes 44. The lower end of the first column 11, the first hanger rod joint 65, the second hanger rod joint 63 and the lower end of the fourth column 14 each are rotatably provided with one of the first bottom connecting tubes 43, and the first bottom connecting tubes 43 can rotate upward from the horizontal state to the vertical state or state downward from the vertical state to the horizontal state only by taking the lower end of the first column 11, the first hanger rod joint 65, the second hanger rod joint 63 and the fourth column 14 as rotating centers. The first bottom connector 41 is provided with a plurality of limiting portions, the plurality of first bottom connecting tubes 43 are in one-to-one rotatable connection with the plurality of limiting portions on the first bottom connector 41, and the first bottom connecting tubes 43 can rotate upward from the horizontal state to the vertical state or state downward from the vertical state to the horizontal state only by taking the limiting portions as rotating centers, to provide an effective support force for the bottom of the cart, thereby facilitating bearing. Similarly, the first hanger rod joint 65, the lower end of the second column 12, the lower end of the third column 13 and the second hanger rod joint 63 each are rotatably provided with one of the second bottom connecting tubes. The second bottom connector 42 is provided with a plurality of limiting portions, and the plurality of second bottom connecting tubes 44 are in one-to-one rotatable connection with the plurality of limiting portions on the second bottom connector 42.

As shown in FIG. 1 and FIG. 4, the first folding mechanism 21 and the second folding mechanism 22 each include first linkage 211, second linkage 212, third linkage 213, fourth linkage 214, fifth linkage 215, and sixth linkage 216. The first linkage 211, the second linkage 212 and the third linkage 213 are rotatably connected end to end in sequence; the fourth linkage 214, the fifth linkage 215 and the sixth linkage 216 are rotatably connected end to end in sequence; a middle of the first linkage 211 is rotatably connected to a middle of the fourth linkage 214, a middle of the second linkage 212 is rotatably connected to a middle of the fifth linkage 215, and a middle of the third linkage 213 is rotatably connected to a middle of the sixth linkage 216. The first folding mechanism 21 and the second folding mechanism 22 have the same structure and are symmetrical in position. The mounting mode of the two folding mechanisms is described by taking the illustration of the second folding mechanism 22 in FIG. 4 as an example. Linkage slide sleeves 217 are slidably arranged on the first column 11, the second column 12, the third column 13 and the fourth column 14. The first linkage 211 of the first folding mechanism 21 is rotatably connected to the upper end of the first column 11, the third linkage 213 of the first folding mechanism 21 is rotatably connected to the linkage slide sleeve 217 on the second column 12, the first linkage 211 of the second folding mechanism 22 is rotatably connected to the upper end of the fourth column 14, and the third linkage 213 of the second folding mechanism 22 is rotatably connected to the linkage slide sleeve 217 on the third column 13. The fourth linkage 214 of the first folding mechanism 21 is rotatably connected to the linkage slide sleeve 217 on the first column 11, the sixth linkage 216 of the first folding mechanism 21 is rotatably connected to the upper end of the second column 12, the fourth linkage 214 of the second folding mechanism 22 is rotatably connected to the linkage slide sleeve 217 on the fourth column 14, and the sixth linkage 216 of the second folding mechanism 22 is rotatably connected to the upper end of the third column 13.

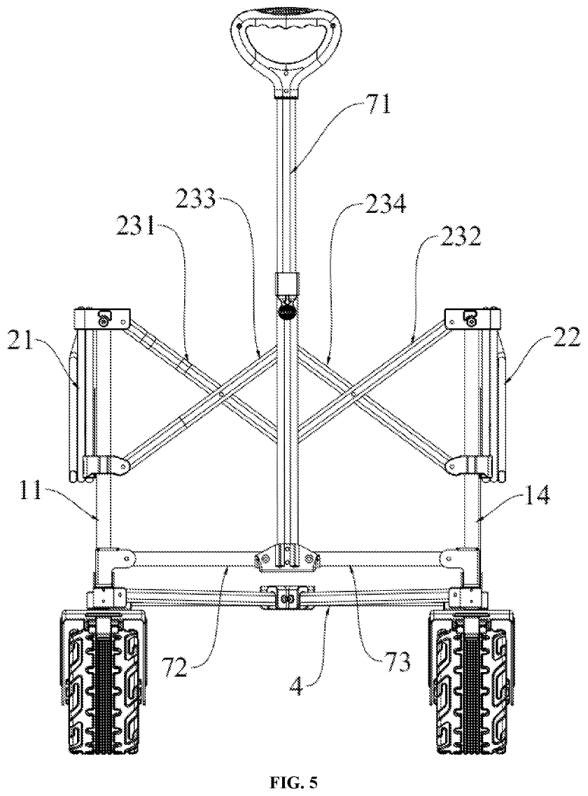

As shown in FIG. 1 and FIG. 5, the third folding mechanism 23 includes seventh linkage 231, eighth linkage 232, ninth linkage 233, and tenth linkage 234. A first end of the seventh linkage 231 is rotatably connected to a first end of the eighth linkage 232, a first end of the ninth linkage 233 is rotatably connected to a first end of the tenth linkage 234, a middle of the seventh linkage 231 is rotatably connected to a middle of the ninth linkage 233, and a middle of the eighth linkage 232 is rotatably connected to a middle of the tenth linkage 234. A second end of the seventh linkage 231 is rotatably connected to the upper end of the first column 11, a second end of the eighth linkage 232 is rotatably connected to the upper end of the fourth column 14, a second end of the ninth linkage 233 is rotatably connected to the linkage slide sleeve 217 on the first column 11, and a second end of the tenth linkage 234 is rotatably connected to the linkage slide sleeve 217 on the fourth column 14.

As shown in FIG. 1 to FIG. 4, the expandable cart with an unfoldable rear frame includes handle mechanism 7. The handle mechanism 7 includes telescopic rod 71, first connecting tube 72, and second connecting tube 73. A limiting member is connected to a lower end of the telescopic rod 71, a first end of the first connecting tube 72 is rotatably connected to a first side of the limiting member, a first end of the second connecting tube 73 is rotatably connected to a second side of the limiting member, the first side of the limiting member is opposite to the first column 11, and the second side of the limiting member is opposite to the fourth column 14. Restricted by the limiting member, the first connecting tube 72 and the second connecting tube 73 can only rotate downward from an inclined upward state in the folded state to the horizontal state in the unfolded state, or rotate upward from the horizontal state in the unfolded state. The first connecting tube 72 and the second connecting tube 73 cannot continue to rotate downward from the horizontal state. A second end of the first connecting tube 72 is rotatably connected to the lower end of the first column 11, and a second end of the second connecting tube 73 is rotatably connected to the lower end of the fourth column 14. When the first connecting tube 72 and the second connecting tube 73 rotate around a rotating shaft at the second end, a free end of the telescopic rod 71 moves away from the cart frame or moves close to the cart. When the free end of the telescopic rod 71 is far away from the cart, there is a certain angle between the telescopic rod 71 and a plane where the first column 11 and the fourth column 14 are located, which is convenient for a user to drag. The second end of the telescopic rod 71 is connected to a pull ring, which further facilitates the user to tow the cart. Rollers are respectively provided at a bottom of the first column 11, a bottom of the second column 12, a bottom of the third column 13 and a bottom of the fourth column 14. The rollers disposed at the bottom of the first column 11 and the bottom of the fourth column 14 are universal wheels.

It should be understood that in the description of the present disclosure, terms such as “first” and “second” are used merely for a descriptive purpose, and should not be construed as indicating or implying relative importance, or implicitly indicating the number of indicated technical features. Thus, features defined with “first” and “second” may explicitly or implicitly include one or more of the features. In the description of the present disclosure, the term “a plurality of” means two or more, unless otherwise specifically defined.

In the present disclosure, unless otherwise clearly specified, the terms “installation”, “interconnection”, “connection” and “fixation” are intended to be understood in a broad sense. For example, the “connection” may be a fixed connection, removable connection or integral connection; may be a mechanical connection or electrical connection; may be a direct connection or indirect connection using a medium; and may be a communication or interaction between two elements. Those of ordinary skill in the art may understand the specific meanings of the above terms in the present disclosure based on specific situations.

In the present disclosure, unless otherwise explicitly stipulated, “a first feature is above or below a second feature” may indicate that “the first and second features are in direct contact” or “the first and second features are in indirect contact through an intermediate feature”. In addition, when it is described that the first feature is “over”, “above” and “on” the second feature, it indicates that the first feature is directly or obliquely above the second feature, or simply indicates that an altitude of the first feature is higher than that of the second feature. When it is described that a first feature is “under”, “below” or “beneath” a second feature, it indicates that the first feature is directly or obliquely under the second feature or simply indicates that the first feature is lower than the second feature.

In the description of this specification, the description with reference to the terms such as “one embodiment”, “some embodiments”, “embodiments”, “an example”, “a specific example” and “some examples” indicate that the specific features, structures, materials, or characteristics described with reference to the embodiment or example are included in at least one embodiment or example of the present disclosure. In this specification, the schematic expression of the above terms is not necessarily directed to the same embodiment or example. Moreover, the specific features, structures, materials, or characteristics described may be combined in a suitable manner in any one or more embodiments or examples. In addition, those skilled in the art may combine different embodiments or examples described in this specification and characteristics of the different embodiments or examples without mutual contradiction.

Although the embodiments of the present disclosure have been described above, it should be understood that the above embodiments are exemplary, and may not be construed as limitations to the present disclosure. A person of ordinary skill in the art may make various changes, modifications, replacements and variations on the above embodiments within the scope of the present disclosure.

What is claimed is:

1. An expandable cart with an unfoldable rear frame, comprising a first column, a second column, a third column, a fourth column, a first folding mechanism, a second folding mechanism, a third folding mechanism, a rear frame mechanism, and a bottom support mechanism, wherein
the first column, the second column, the third column, and the fourth column are arranged at intervals in a rectangular shape, and have lower ends all connected to the bottom support mechanism, and the bottom support mechanism is allowed to be folded upward;
the first folding mechanism is connected between the first column and the second column, the second folding mechanism is connected between the third column and the fourth column, and the third folding mechanism is connected between the fourth column and the first column; and
the rear frame mechanism is disposed between the second column and the third column, a lower end of the rear frame mechanism is rotatably connected to the lower end of the second column and the lower end of the third column at a first limited angle, and an upper end of the rear frame mechanism is detachably connected to an upper end of the second column and an upper end of the third column.

2. The expandable cart according to claim 1, wherein the rear frame mechanism comprises a fifth column, a sixth column, and a fourth folding mechanism, wherein
the fourth folding mechanism is connected between the fifth column and the sixth column, a lower end of the fifth column is rotatably connected to the lower end of the second column at a second limited angle, a lower end of the sixth column is rotatably connected to the lower end of the third column at a third limited angle, an upper end of the fifth column is allowed to be engaged with the upper end of the second column, and an upper end of the sixth column is allowed to be engaged with the upper end of the third column.

3. The expandable cart according to claim 2, wherein a first top corner fastener is provided at each of the upper end of the fifth column and the upper end of the sixth column, and a hook is provided on the first top corner fastener;
a second top corner fastener is provided at each of the upper end of the second column and the upper end of the third column, and a groove is formed in the second top corner fastener; and
a hook on the fifth column and a hook on the sixth column are allowed to be in one-to-one engagement with a groove in the second column and a groove in the third column.

4. The expandable cart according to claim 3, wherein the fourth folding mechanism comprises a first cross bent tube, a second cross bent tube, a first cross straight tube, a second cross straight tube, a first laying-down slide sleeve, and a second laying-down slide sleeve, wherein
the first laying-down slide sleeve and the second laying-down slide sleeve are in one-to-one slidable connection with the fifth column and the sixth column, respectively;
the first cross bent tube is rotatably connected to the second cross bent tube, a first end of the first cross bent tube is rotatably connected to the first top corner fastener on the fifth column, and a first end of the second cross bent tube is rotatably connected to the first laying-down slide sleeve;
the first cross straight tube is rotatably connected to the second cross straight tube, a first end of the first cross straight tube is rotatably connected to the first top corner fastener on the sixth column, and a first end of the second cross straight tube is rotatably connected to the second laying-down slide sleeve; and
a second end of the first cross bent tube is rotatably connected to a second end of the first cross straight tube, and a second end of the second cross bent tube is rotatably connected to a second end of the second cross straight tube.

5. The expandable cart according to claim 1, wherein a support mechanism is provided between the second column and the third column, and the support mechanism comprises a first transverse support tube, a second transverse support tube and a transverse support connector, wherein
a first end of the first transverse support tube is rotatably connected to the lower end of the second column, and a first end of the second transverse support tube is rotatably connected to the lower end of the third column; and
a second end of the first transverse support tube and a second end of the second transverse support tube are both rotatably connected to the transverse support connector.

6. The expandable cart according to claim 1, further comprising a first hanger rod and a second hanger rod, wherein
an upper end of the first hanger rod and an upper end of the second hanger rod are rotatably connected to a middle of the first folding mechanism and a middle of the second folding mechanism, respectively;
a first hanger rod joint is slidably arranged on the first hanger rod, a second hanger rod joint is slidably arranged on the second hanger rod, and limiting joints are respectively provided at a lower end of the first hanger rod and a lower end of the second hanger rod; and
the first hanger rod joint and the second hanger rod joint are both connected to the bottom support mechanism.

7. The expandable cart according to claim 6, wherein the bottom support mechanism comprises a first bottom connector, a second bottom connector, a plurality of first bottom connecting tubes, and a plurality of second bottom connecting tubes, wherein
the lower end of the first column, the first hanger rod joint, the second hanger rod joint and the lower end of the fourth column each are rotatably provided with one of the plurality of first bottom connecting tubes, and the plurality of first bottom connecting tubes are all rotatably connected to the first bottom connector; and
the first hanger rod joint, the lower end of the second column, the lower end of the third column and the second hanger rod joint each are rotatably provided with one of the plurality of second bottom connecting tubes, and the plurality of second bottom connecting tubes are all rotatably connected to the second bottom connector.

8. The expandable cart according to claim 1, wherein the first folding mechanism and the second folding mechanism each comprise a first linkage, a second linkage, a third linkage, a fourth linkage, a fifth linkage, and a sixth linkage, wherein
the first linkage, the second linkage and the third linkage are rotatably connected end to end in sequence; the fourth linkage, the fifth linkage and the sixth linkage are rotatably connected end to end in sequence; a middle of the first linkage is rotatably connected to a middle of the fourth linkage, a middle of the second linkage is rotatably connected to a middle of the fifth linkage, and a middle of the third linkage is rotatably connected to a middle of the sixth linkage;
linkage slide sleeves are slidably arranged on the first column, the second column, the third column and the fourth column;
the first linkage of the first folding mechanism is rotatably connected to an upper end of the first column, the third linkage of the first folding mechanism is rotatably connected to the linkage slide sleeve on the second column, the first linkage of the second folding mechanism is rotatably connected to an upper end of the fourth column, and the third linkage of the second folding mechanism is rotatably connected to the linkage slide sleeve on the third column; and
the fourth linkage of the first folding mechanism is rotatably connected to the linkage slide sleeve on the first column, the sixth linkage of the first folding mechanism is rotatably connected to the upper end of the second column, the fourth linkage of the second folding mechanism is rotatably connected to the linkage slide sleeve on the fourth column, and the sixth linkage of the second folding mechanism is rotatably connected to the upper end of the third column.

9. The expandable cart according to claim 8, wherein the third folding mechanism comprises a seventh linkage, an eighth linkage, a ninth linkage, and a tenth linkage, wherein
a first end of the seventh linkage is rotatably connected to a first end of the eighth linkage, a first end of the ninth linkage is rotatably connected to a first end of the tenth linkage, a middle of the seventh linkage is rotatably connected to a middle of the ninth linkage, and a middle of the eighth linkage is rotatably connected to a middle of the tenth linkage; and
a second end of the seventh linkage is rotatably connected to the upper end of the first column, a second end of the eighth linkage is rotatably connected to the upper end of the fourth column, a second end of the ninth linkage is rotatably connected to the linkage slide sleeve on the first column, and a second end of the tenth linkage is rotatably connected to the linkage slide sleeve on the fourth column.

10. The expandable cart according to claim 1, further comprising a handle mechanism, wherein the handle mechanism comprises a telescopic rod, a first connecting tube, and a second connecting tube, wherein a first end of the first connecting tube and a first end of the second connecting tube are both rotatably connected to a first end of the telescopic rod, and a second end of the first connecting tube and a second end of the second connecting tube are in one-to-one rotatable connection with the lower end of the first column and the lower end of the fourth column.

11. The expandable cart according to claim 2, wherein a support mechanism is provided between the second column and the third column, and the support mechanism comprises a first transverse support tube, a second transverse support tube and a transverse support connector, wherein
a first end of the first transverse support tube is rotatably connected to the lower end of the second column, and a first end of the second transverse support tube is rotatably connected to the lower end of the third column; and
a second end of the first transverse support tube and a second end of the second transverse support tube are both rotatably connected to the transverse support connector.

12. The expandable cart according to claim 3, wherein a support mechanism is provided between the second column and the third column, and the support mechanism comprises a first transverse support tube, a second transverse support tube and a transverse support connector, wherein
a first end of the first transverse support tube is rotatably connected to the lower end of the second column, and a first end of the second transverse support tube is rotatably connected to the lower end of the third column; and
a second end of the first transverse support tube and a second end of the second transverse support tube are both rotatably connected to the transverse support connector.

13. The expandable cart according to claim 4, wherein a support mechanism is provided between the second column and the third column, and the support mechanism comprises a first transverse support tube, a second transverse support tube and a transverse support connector, wherein
a first end of the first transverse support tube is rotatably connected to the lower end of the second column, and a first end of the second transverse support tube is rotatably connected to the lower end of the third column; and
a second end of the first transverse support tube and a second end of the second transverse support tube are both rotatably connected to the transverse support connector.

14. The expandable cart according to claim 2, further comprising a first hanger rod and a second hanger rod, wherein
an upper end of the first hanger rod and an upper end of the second hanger rod are rotatably connected to a middle of the first folding mechanism and a middle of the second folding mechanism, respectively;
a first hanger rod joint is slidably arranged on the first hanger rod, a second hanger rod joint is slidably arranged on the second hanger rod, and limiting joints are respectively provided at a lower end of the first hanger rod and a lower end of the second hanger rod; and
the first hanger rod joint and the second hanger rod joint are both connected to the bottom support mechanism.

15. The expandable cart according to claim 3, further comprising a first hanger rod and a second hanger rod, wherein
an upper end of the first hanger rod and an upper end of the second hanger rod are rotatably connected to a middle of the first folding mechanism and a middle of the second folding mechanism, respectively;
a first hanger rod joint is slidably arranged on the first hanger rod, a second hanger rod joint is slidably arranged on the second hanger rod, and limiting joints are respectively provided at a lower end of the first hanger rod and a lower end of the second hanger rod; and
the first hanger rod joint and the second hanger rod joint are both connected to the bottom support mechanism.

16. The expandable cart according to claim 4, further comprising a first hanger rod and a second hanger rod, wherein
an upper end of the first hanger rod and an upper end of the second hanger rod are rotatably connected to a middle of the first folding mechanism and a middle of the second folding mechanism, respectively;
a first hanger rod joint is slidably arranged on the first hanger rod, a second hanger rod joint is slidably arranged on the second hanger rod, and limiting joints are respectively provided at a lower end of the first hanger rod and a lower end of the second hanger rod; and
the first hanger rod joint and the second hanger rod joint are both connected to the bottom support mechanism.

17. The expandable cart according to claim 2, wherein the first folding mechanism and the second folding mechanism each comprise a first linkage, a second linkage, a third linkage, a fourth linkage, a fifth linkage, and a sixth linkage, wherein
the first linkage, the second linkage and the third linkage are rotatably connected end to end in sequence; the fourth linkage, the fifth linkage and the sixth linkage are rotatably connected end to end in sequence; a middle of the first linkage is rotatably connected to a middle of the fourth linkage, a middle of the second linkage is rotatably connected to a middle of the fifth linkage, and a middle of the third linkage is rotatably connected to a middle of the sixth linkage;
linkage slide sleeves are slidably arranged on the first column, the second column, the third column and the fourth column;
the first linkage of the first folding mechanism is rotatably connected to an upper end of the first column, the third linkage of the first folding mechanism is rotatably connected to the linkage slide sleeve on the second column, the first linkage of the second folding mechanism is rotatably connected to an upper end of the fourth column, and the third linkage of the second folding mechanism is rotatably connected to the linkage slide sleeve on the third column; and
the fourth linkage of the first folding mechanism is rotatably connected to the linkage slide sleeve on the first column, the sixth linkage of the first folding mechanism is rotatably connected to the upper end of the second column, the fourth linkage of the second folding mechanism is rotatably connected to the linkage slide sleeve on the fourth column, and the sixth linkage of the second folding mechanism is rotatably connected to the upper end of the third column.

18. The expandable cart according to claim 3, wherein the first folding mechanism and the second folding mechanism each comprise a first linkage, a second linkage, a third linkage, a fourth linkage, a fifth linkage, and a sixth linkage, wherein
the first linkage, the second linkage and the third linkage are rotatably connected end to end in sequence; the fourth linkage, the fifth linkage and the sixth linkage are rotatably connected end to end in sequence; a middle of the first linkage is rotatably connected to a middle of the fourth linkage, a middle of the second linkage is rotatably connected to a middle of the fifth linkage, and a middle of the third linkage is rotatably connected to a middle of the sixth linkage;
linkage slide sleeves are slidably arranged on the first column, the second column, the third column and the fourth column;
the first linkage of the first folding mechanism is rotatably connected to an upper end of the first column, the third linkage of the first folding mechanism is rotatably connected to the linkage slide sleeve on the second column, the first linkage of the second folding mechanism is rotatably connected to an upper end of the fourth column, and the third linkage of the second folding mechanism is rotatably connected to the linkage slide sleeve on the third column; and
the fourth linkage of the first folding mechanism is rotatably connected to the linkage slide sleeve on the first column, the sixth linkage of the first folding mechanism is rotatably connected to the upper end of the second column, the fourth linkage of the second folding mechanism is rotatably connected to the linkage slide sleeve on the fourth column, and the sixth linkage of the second folding mechanism is rotatably connected to the upper end of the third column.

19. The expandable cart according to claim 4, wherein the first folding mechanism and the second folding mechanism each comprise a first linkage, a second linkage, a third linkage, a fourth linkage, a fifth linkage, and a sixth linkage, wherein
the first linkage, the second linkage and the third linkage are rotatably connected end to end in sequence; the fourth linkage, the fifth linkage and the sixth linkage are rotatably connected end to end in sequence; a middle of the first linkage is rotatably connected to a middle of the fourth linkage, a middle of the second linkage is rotatably connected to a middle of the fifth linkage, and a middle of the third linkage is rotatably connected to a middle of the sixth linkage;
linkage slide sleeves are slidably arranged on the first column, the second column, the third column and the fourth column;
the first linkage of the first folding mechanism is rotatably connected to an upper end of the first column, the third linkage of the first folding mechanism is rotatably connected to the linkage slide sleeve on the second column, the first linkage of the second folding mechanism is rotatably connected to an upper end of the fourth column, and the third linkage of the second folding mechanism is rotatably connected to the linkage slide sleeve on the third column; and
the fourth linkage of the first folding mechanism is rotatably connected to the linkage slide sleeve on the first column, the sixth linkage of the first folding mechanism is rotatably connected to the upper end of the second column, the fourth linkage of the second folding mechanism is rotatably connected to the linkage slide sleeve on the fourth column, and the sixth linkage of the second folding mechanism is rotatably connected to the upper end of the third column.

20. The expandable cart according to claim 2, further comprising a handle mechanism, wherein the handle mechanism comprises a telescopic rod, a first connecting tube, and a second connecting tube, wherein a first end of the first connecting tube and a first end of the second connecting tube are both rotatably connected to a first end of the telescopic rod, and a second end of the first connecting tube and a second end of the second connecting tube are in one-to-one rotatable connection with the lower end of the first column and the lower end of the fourth column.
